(19) United States
(12) Patent Application Publication
(10) Pub. No.: US 2003/0231202 A1
(43) Pub. Date: Dec. 18, 2003

(54) System and method for facilitating presentation of a themed slide show

(76) Inventors: Kathryn L. Parker, Sammamish, WA (US); Isabella Carniato, Seattle, WA (US)

Correspondence Address: SCOTT B. STROHM, SHOOK, HARDY & BACON L.L.P., 1200 Main Street, Kansas City, MO, 64105-2118, US

(21) Appl. No.: 10/174,137

(22) Filed: Jun. 18, 2002

(51) Int. Cl. G09G 5/00

(52) U.S. Cl. 345/730

(57) ABSTRACT

A method and system for execution in a graphical user interface environment are provided. The method and system are used to facilitate presentation of image files in a themed slide show on the graphical user interface. A set of digital image files for possible inclusion in the themed slide show are presented on the graphical user interface. Thereafter, monitoring takes place to check for receipt of an indication that at least a portion of the set of digital image files are to be included in the themed slide show. A number of different themes, each having predetermined theme properties, is presented on the graphical user interface for selection. The themes may include selected corresponding audio files. The selected theme is applied to the set of selected digital image files. Applying the selected theme properties to the set of digital image files then creates the slide show.

### CROSS-REFERENCE TO RELATED APPLICATIONS

None.

### STATEMENT REGARDING FEDERALLY SPONSORED RESEARCH OR DEVELOPMENT

None

### TECHNICAL FIELD

In general, the present invention relates to computer software, and more particularly, to a method and system for facilitating presentation of a themed slide show using a computer system and a display device.

### BACKGROUND OF THE INVENTION

Personal computers (PCs) are increasingly being used for purposes far different from the standard word-processing and data handling modes. PCs today are being used outside of offices and within homes for entertainment purposes as well as the standard computing purposes. One such purpose involves the handling of digital images.

Digital cameras are now being widely used by consumers. In use, the digital cameras record and store digital images. These digital images can be moved from the more limited storage area of the camera to the storage area on a PC or other computing device. These storage areas are rapidly increasing in size, such that storage of a very large quantity of digital images is possible without affecting the operability of the computing device.

People are often prone to take a great many pictures, whether digital or the ordinary film pictures. When the standard film is developed, the consumer receives the pictures in print or slide form. In print form, the pictures can be organized into photo albums. Frequently, however, the photos simply accumulate in drawers or boxes. This storage and organization makes the pictures less useful, in that it is cumbersome to display the pictures to those that might have some interest. In slide form, the slides can be organized into slide carousels. This requires the user to buy and store the carousels. Neither of the more traditional methods of storing pictures allows the user to organize the pictures in such a way that they can be easily shared with others.

As stated above, digital pictures can be stored on a computing device. These digital images can easily be organized in storage on the computing device using the well-known file and folder system. Thus, storage of the digital pictures on the computing device solves some of the problems associated with the more traditional methods of picture storage. However, the problem of meaningfully sharing the pictures with others remains.

In one prior approach, a user of the computing device is able to select desired digital images for presentation. The order of the pictures can be adjusted, as well as the time delay between picture presentation. A user may also select a digital music file to play as the pictures are being presented on the display. While this offers more to the viewer of the pictures than simply clicking through one digital image after another, the presentation does not take full-advantage of the opportunities available in the merger of the computing device and the digital images.

It would be desirable to provide to the user of the computing device an opportunity to create a slide show of various digital images that provides a rich experience to the viewer of the slide show. Therefore, there exists a need to improve the user and viewer experience in the presentation of digital images.

### BRIEF SUMMARY OF THE INVENTION

The present invention is directed to a method and computer application for execution in a graphical user interface environment. The method and system are used to facilitate presentation of image files in a themed slide show on the graphical user interface. A set of digital image files for possible inclusion in the themed slide show is presented on the graphical user interface. Thereafter, monitoring takes place to check for receipt of an indication that at least a portion of the set of digital image files is to be included in the themed slide show. A number of different themes, each having predetermined theme properties, are presented on the graphical user interface for selection. The themes may include selected corresponding audio files. The selected theme is applied to the set of selected digital image files. The slide show is then created by applying the selected theme properties to the set of digital image files.

Additional advantages and novel features of the invention will be set forth in the description which follows, and in part will become apparent to those skilled in the art upon examination of the following, or may be learned from practice of the invention.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention; and

FIG. 2 is a flow chart illustrating certain aspects of the present invention.

### DETAILED DESCRIPTION OF THE INVENTION

The present invention provides a method and user interface for use in the presentation of digital images stored in a computing device. The invention is used to easily control the presentation aspects to provide a better viewing experience. The user is able to present a series of digital images using an applied theme or a custom theme. The theme incorporates options selectable by the user, such as transition times, borders, captions, other special effects, music playlists and so on. A number of selectable themes are preferably provided, as well as the option to allow creation of custom themes.

Having briefly described an embodiment of the present invention, an exemplary operating environment for the present invention is described below.

Exemplary Operating Environment

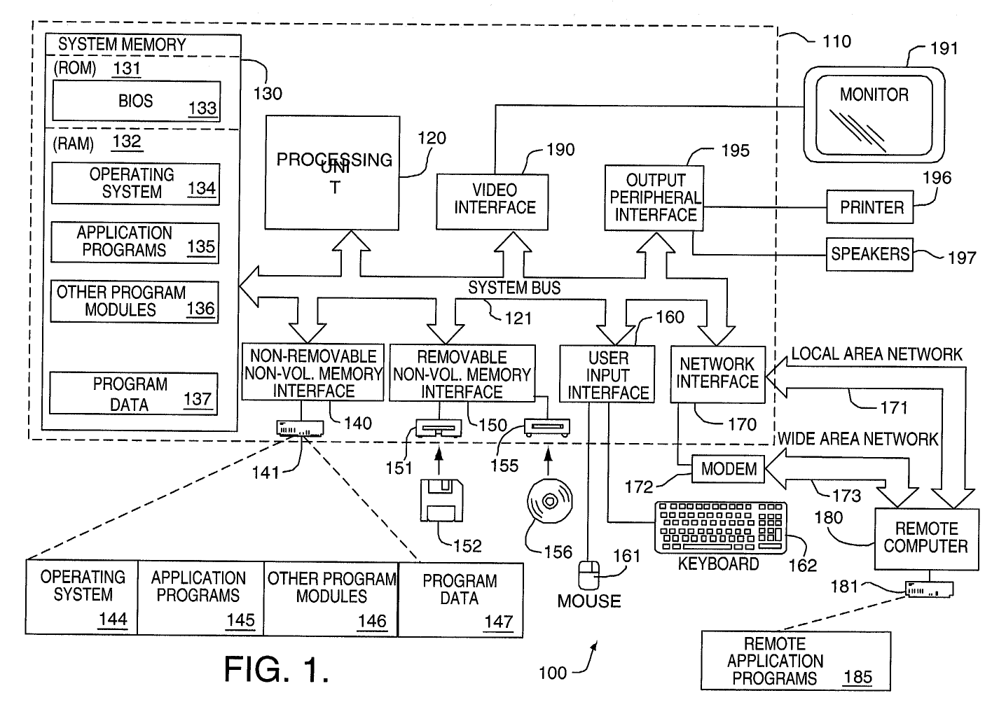

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system 100 for implementing the invention includes a general purpose computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

System and Method for Indicating Focus

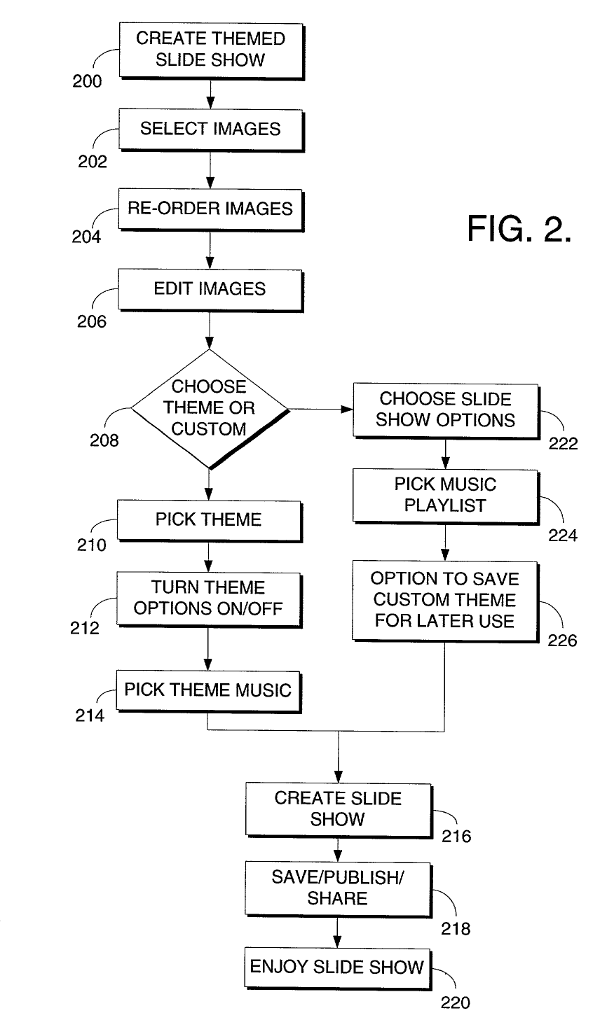

As best seen in FIG. 2, a flow chart illustrating a method of the present invention is shown. The flow chart is illustrative of the user interface steps presented to the user of the computer 110 to create a themed slide show. Preferably, these steps are presented to the user as a “wizard.” A wizard is an interactive help utility within an application that guides the user through each step of a particular task, in this instance the creation of a themed slide show. The method begins at 200 with the user of the computer 110 indicating the desire to create a themed slide show. The indication by the user could be, for example, the user selecting the “create themed slide show” option from a drop-down menu or by selecting a “create themed slide show” control button.

After indicating the desire to create a themed slide show, the user is prompted to select the images that are desired to be presented in the slide show, as indicated at 202. The images can be selected by use of a check-box, or by dragging and dropping copies of the images into a slide show folder. The files of the images themselves are not moved. Rather, the image files remain at their current location and a pointer to that location is used to obtain the image when needed. It is likely that all of the image files will be located in one area of the computer, such as a pictures folder or sub-folder. It could also be the case that the user is presented with all files of certain types known to represent images, and from which the user will select files for use in the slide show. When the user has finished selecting files, an indication is given that the file selection process is complete. The user is then presented with the images, in a given order. The user is then presented with an opportunity to reorder the images, as shown at 204. The reordering process can be triggered by an indication from the user that the user desires to reorder the images. The reordering can be accomplished by renumbering the images, or by dragging the images from one location in the order to another.

When the user has the images selected and in the desired order, the user is prompted to make any needed editorial changes to the images, as indicated at 206. These editorial changes can be made to some, none, or all of the images selected. As an illustrative example that is in no way intended to be limiting, the editorial changes can include cropping the image, adding captions, rotating the image, changing the coloring (such as switching from color to black and white or reducing the redness in the eyes of a person in the image) or adjusting the contrast or brightness. Other editorial changes could be made at this stage as well.

At this point, the user is prompted to choose a supplied theme or to create a custom theme for the slide show, as indicated at 208. If the user selects to use a supplied theme, the user is presented with the available theme options. The list of options can be presented in a list form, such as a drop down menu. Other methods of presenting the theme options are, of course, available and are within the scope of the present invention. As an example, and without limitation, the theme options could include such things as a birthday theme, an anniversary theme, a vacation theme, a wedding theme or a holiday theme. As can be seen, the possible theme options are virtually limitless. A number of available themes could be provided to the user initially, with the availability to the user of supplementing new themes at a later time. For example, the user could be given the opportunity to purchase or download further theme packages, as additional themes become available. After the user is presented with the available theme options, the user selects one theme, as indicated at 210.

As shown at 212, the user is next presented with the option configuration of the selected theme and is given the opportunity to modify the theme properties as desired. The theme options are presented to the user, such as by a series of options with checkboxes. The user can select or deselect any of the options provided to customize the provided theme. For example, if the selected theme used a transition time of five seconds per picture, the user could opt to shorten or enlarge the transition time. As another example, the user could change the theme-provided border for the pictures. Of course, the user can use the theme as presented without any modification whatsoever.

The wizard then prompts the user to select the theme music, if any, as shown at 214. The theme music in the provided themes is coordinated with the overall theme. For example, a birthday theme could include various versions of the birthday song, or a wedding theme could include traditional wedding music. The user could also customize this theme music by adding music files to the provided and selected theme music. As with the theme-provided options, the user can also merely accept the theme-provided music.

After the music, if any, has been selected, the themed slide show is created, as shown at 216. In the creation, all of the user-inputs and theme-provided options are used to assemble the slide show. The created themed slide show may then be saved, for example as an .mpeg2 or .wav file, published to a network or otherwise shared, as shown at 218. Thereafter, the created slide show may be retrieved and viewed as desired, as shown at 220. The created themed slide show provides to the viewer a richer viewing experience than heretofore provided. Moreover, the themed slide show is created easily and the user of computer 110 is guided through the process outlined in FIG. 2 to provide an intuitive and easy-to-follow process.

Returning to FIG. 2, if the user selects to create a custom theme at step 208, a number of different theme options are displayed for selection by the user, as shown at 222. These options can be presented in any of a number of different ways, such as by checkboxes, drop-down menus, and can be presented in categories or as one master list. By way of example and without limitation, the slide show options can include such things as the transition time between slides, slide borders and shapes, caption fonts, color tones, animations, picture information or different styles, such as a slightly blurred image. After the user selects the slide show options, the wizard presents the option to include a music playlist, as shown at 224. If the user indicates a playlist is desired, the available music files are presented for selection to the user. These music files will include those that are available under the theme options, as well as the other music files stored on the computer 110. The user is then presented the opportunity to save the theme for future use, as shown at 226. This allows the user to save all of the theme properties created during steps 222 and 224. For example, if the user created a theme for a holiday party, the user could save this custom theme for use in creating a slide show for future holiday parties. Again, the possibilities in the creation of various custom themes are virtually limitless.

After the custom theme is created, the wizard creates the slide show and the user is given the option to save it, publish it or otherwise share it, and view it as described above in connection with steps 216, 218 and 220.

The wizard implementing the steps as described above with reference to FIG. 2 can be implemented as part of the operating system software or could be implemented as a separate application for managing image files.

As can be understood, the method and system allow a user to easily sahre image files existing on a computer. The themed slide show that is created provides a rich viewing experience. By providing such an experience, the computer user is better able to take advantage of the entertainment capability of the computer. The ability provided by the present invention thus allows computer users to more meaningfully share digital images with others.

The present invention has been described in relation to particular embodiments, which are intended in all respects to be illustrative rather than restrictive. Alternative embodiments will become apparent to those skilled in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated and with the scope of the claims.

What is claimed is:

1. A computer-implemented method for execution in a graphical user interface environment to facilitate presentation of image files in a themed slide show, comprising:
presenting on the graphical user interface a set of digital image files for possible inclusion in the themed slide show;
receiving an indication that at least a portion of the set of digital image files are to be included in the themed slide show;
presenting on the graphical user interface a plurality of themes, having predetermined theme properties, to be applied to the themed slide show;
receiving an indication that one of the themes is to be applied to the set of selected digital image files; and
creating the themed slide show by applying the selected theme properties to the set of selected digital image files to create the slide show.

2. A computer-implemented method as recited in claim 1, further comprising:
presenting, after receiving the indication of a theme selection, the properties associated with the selected theme; and
allowing each of the displayed theme properties to be altered.

3. A computer-implemented method as recited in claim 2, further comprising:
presenting for selection available audio files for inclusion in the themed slide show.

4. A computer-implemented method as recited in claim 3, wherein the available audio files include music files pre-coordinated for use with the selected theme.

5. A computer-implemented method as recited in claim 1, wherein the portion of the set of digital image files to be included in the themed slide show is presented on the graphical user interface, the method further comprising:
presenting on the graphical user interface editing options available for editing the digital image files to be included in the themed slide show.

6. A computer-implemented method as recited in claim 5, wherein the editing options include re-ordering the image files.

7. A computer system having a processor, a memory and an operating environment, the computer system operable to execute the method as recited in claim 1.

8. A computer-readable medium containing instructions for executing the method of claim 1.

9. A computer-implemented method for execution in a graphical user interface environment to facilitate presentation of image files in a themed slide show, comprising:
presenting on the graphical user interface a set of digital image files for possible inclusion in the themed slide show;
receiving an indication that at least a portion of the set of digital image files are to be included in the themed slide show;
presenting on the graphical user interface a plurality of slide show options for the creation of a slide show theme to be applied to the themed slide show;
receiving an indication that at least one of the slide show options is to be applied to the slide show theme; and
creating the themed slide show by applying the selected slide show theme options to the slide show.

10. A computer-implemented method as recited in claim 9, further comprising:
presenting, after receiving the indication of the slide show options, audio files available for inclusion in the themed slide show.

11. A computer-implemented method as recited in claim 10, wherein the portion of the set of digital image files to be included in the themed slide show is presented on the graphical user interface, the method further comprising:
presenting on the graphical user interface editing options available for editing the digital image files to be included in the themed slide show.

12. A computer-implemented method as recited in claim 11, wherein the editing options include re-ordering the image files.

13. A computer-implemented method as recited in claim 9, further comprising saving the set of selected slide show options on a computer readable medium.

14. A computer system having a processor, a memory and an operating environment, the computer system operable to execute the method as recited in claim 9.

15. A computer-readable medium containing instructions for executing the method of claim 9.
